(19) United States
(12) Patent Application Publication
(10) Pub. No.: US 2012/0159835 A1
(43) Pub. Date: Jun. 28, 2012

(54) Submersible Combination Bait Storage and Transport Holder and Fish Lure Apparatus and Method

(76) Inventor: Joseph C. Saltsman, Derby, VT (US)

(21) Appl. No.: 13/410,186

(22) Filed: Mar. 1, 2012

(51) Int. Cl. A01K 97/05

(52) U.S. Cl. 43/54.1

(57) ABSTRACT

A combination bait storage and transport holder, and fish lure apparatus and related method is disclosed that enables a user to store and transport bait and lure water life (target fish), all with the same container. This apparatus comprises a transparent or semitransparent (substantially transparent) material intended for bait storage, bait transportation and complete submersion in water for fish luring, and comprises at least one fluid passage opening through which water can pass but the bait cannot pass. Once submerged in water, this allows any native water life present to see and/or smell the bait and thereby be lured and attracted to the bait, and allows oxygenated water and bait aroma to flow into and out of the apparatus. There are also one or more closures whereby all openings can be closed at will so that water does not leak water during storage and transportation.

### FIELD OF THE INVENTION

This invention is for a bait holder which houses live bait and allows game fish to view and smell the live bait through the walls of the bait holder. This invention more particularly relates to a multifunction bait holder which can store the bait out of water, transport the bait to a fishing location, completely submerge the bait in the fishing environment and attract water life while submerged.

### BACKGROUND OF THE INVENTION

It is well recognized that the most effective lure for most fishing is live bait. Although many brightly-colored and shiny devices are employed to attract the fish to be caught (target fish) from a distance, the most effective lure as target fish approach is live bait. The movement, odor and appearance of live bait cannot be effectively duplicated by any synthetic means. There is prior art which holds the live bait in position on a lure in proximity to hooks to engage the game fish. Prior art also provides a means to present the bait the fish in the water environment while keeping the bait in a protected bait cage as a luring means of attracting game to be caught, while barring the game fish from ever actually consuming the bait.

However, such bait cages/fish lures have become just another distinct item among the plethora of fishing equipment that fishermen take with them on a fishing trip. Also, typical bait holders are not transparent so the fisherman cannot easily determine the quantity or quality of the bait. In addition, typical bait holders are not designed to be completely submerged in the environment where the game fish are to be caught or to deliver the scent of live bait to the fish. See for example, U.S. Pat. No. 4,603,503 which is expressly designed with buoyancy so as to not be completely submersible (and thereby teaches away from a submersible device), remaining close to the fisherman so bait can be easily removed therefrom for attachment to or near a fish hook, rather away from the fisherman where it can independently act as a fish lure while being protected from being consumed by the target fish. Finally, prior art devices are not designed to simultaneously enable bait transport and using the bait as a lure, without at any point in time having to move the bait between a transport box and a lure.

It is therefore desirable to provide a multi-function bait holder that will store, transport and lure game fish all in one device, without the bait ever having to be removed once it has been placed into the device. Prior art requires more than one apparatus to achieve all of these functions, while associated prior art methods all require the movement of bait from bait storage/transport containers, to bait cages/fish lures. U.S. Pat. No. 4,841,664, for example, particularly FIGS. 7, 8 and 9, discloses a device which houses the bait and attracts prey while the bait is in the water. However, with its plurality of open holes 130 without any closure(s), this device will act like a sieve when it is taken out of the water, so it cannot in any way be used to store or transport bait. It has a single function, which is as a bait cage/fish lure. Further, the spherical nature of this device taken together with its sieve-like openings makes it highly impractical for any type of bait storage and transport, and makes clear that such storage and transport was not in any way considered by the inventors of this device, i.e., that this disclosure teaches away from a multifunctional storage, transport and luring device.

There is other prior art that varies the design of a bait holder for transportation and/or storage with or without ventilation holes. However, none of these designs are intended to attract potential prey while storing the bait. All known prior art devices aside from those already mentioned are configured to either store and transport bait, or to use the bait as a lure, but not both. Examples of bait containers with at least some transparency that cannot be used as lures include: U.S. Pat. Nos. 4,146,989; 4,198,776; 4,275,522; 4,467,548; 4,606,143; 5,802,760; 6,785,999; and 6,421,951. Examples of lures with at least some transparency which cannot be used to store and transport bait include: U.S. Pat. Nos. 4,021,959; 4,475,301; 4,603,502; 4,858,372; 4,961,280; 5,036,617; 5,201,136; and 5,638,630.

This invention solves all the problems with a completely new approach by consolidating all of these functions in one device.

### SUMMARY OF THE INVENTION

A combination bait storage and transport holder, and fish lure apparatus and related method is disclosed that enables a user to store and transport bait and lure water life (target fish), all with the same container. This apparatus comprises a transparent or semitransparent (substantially transparent) material intended for bait storage, bait transportation and complete submersion in water for fish luring, and comprises at least one fluid passage opening through which water can pass but the bait cannot pass. Once submerged in water, this allows any native water life present to see and/or smell the bait and thereby be lured and attracted to the bait, and allows oxygenated water and bait aroma to flow into and out of the apparatus. Ways of facilitating water diffusion while submerged, and at the same time preventing the bait from escaping, include using holes and/or a semipermeable membrane and/or a screen mesh or equivalent as part of the apparatus. There are also one or more closures whereby all openings can be closed at will so that water does not leak water during storage and transportation.

In particular, disclosed herein is a combination bait holder and fish lure apparatus and associated methods, comprising: a substantially transparent container comprising: a container opening through which fishing bait and water can be introduced into and removed from an interior of the container; and at least one fluid passage opening through which water can pass but the bait cannot pass; a container opening closure mating with the container opening for sealably closing the container opening such that the bait and water cannot pass therethrough; and at least one fluid passage closure mating correspondingly with the at least one fluid passage opening for sealably closing the at least one fluid passage opening such that the bait and water cannot pass therethrough; wherein the apparatus is configured such that: when a user of the apparatus is obtaining the bait at a location remote from a fishing location, the user can open the container opening, and close all of the fluid passage openings using the fluid passage closures, introduce the bait and water into the container through the container opening, and then close the container opening using the container opening closure, such that the bait and water are sealably contained within the container; when the bait and water are contained within the container and the container opening and the fluid passage openings are sealably closed, the container is capable of being transported from the remote location to the fishing location substantially without leakage, while storing and preserving the bait in a live condition; when the user wishes to use the bait as a lure at the fishing location, the user can open at least one of the fluid passage openings and completely submerge the apparatus into the water at the fishing location, and by virtue of the container's transparency, make the bait visible to target fish, and by virtue of the at least one opened fluid passage opening, enable the target fish to also detect a scent of the bait, all without removing the bait from the apparatus; whereby: the target fish may be lured toward the apparatus to then be caught by other means proximate to the apparatus.

### BRIEF DESCRIPTION OF THE DRAWINGS

FIG. 1 is a front perspective view of a first preferred embodiment of the invention.

FIG. 2 is a rear perspective view of the first preferred embodiment of FIG. 1.

FIG. 3 shows a second preferred embodiment in which a fluid passage opening is convertible into a container opening, thereby providing a dual-purpose opening.

The features of the invention believed to be novel are set forth in the appended claims. The invention, however, together with further objects and advantages thereof, may best be understood by reference to the following description taken in conjunction with the accompanying drawing(s) summarized below.

### DETAILED DESCRIPTION

The invention disclosed here is a combination bait holder and fish lure apparatus sturdy enough and properly sealable so as to handle bait transport. It is capable of being completely submerged in the water environment local to where the target fish are to be caught. The apparatus is comprised of material and its design is intended to allow the sight and smell of the bait to attract the target fish to be caught while not allowing the bait to escape.

The combination bait holder and fish lure apparatus comprises a translucent or clear container, preferably but not limited to a hard plastic, capable of holding water and bait. The apparatus is configured to hold the water and bait for storage, and for transportation to a fishing location. The apparatus comprises one or more fluid passage openings (windows) that are closed during transportation, using suitable closures. These closed windows prevent the water from leaking out during transport. The apparatus is also sufficiently sturdy to be transported from a “bait source” location remote from the fishing location, e.g., a bait shop, to the fishing location, substantially without leakage.

Once the fishing location is reached, the windows are opened and the box is completely submerged. Because the container is made of clear and/or translucent material, it becomes nearly invisible when in the water. If a fluid passage opening/window is situated on the top of the container, then the fluid passage closure can be removed to provide aeration during storage, in addition to water diffusion during luring. And, as required, bait can be fed during storage.

The result of the foregoing configuration is that this apparatus can be used to:

a. effectively transport bait from a bait source remote from the fishing location, to the fishing location

b. effectively store and preserve bait while at fishing location and elsewhere

c. provide suitable aeration and feeding access to keep bait alive and fed during storage

d. be virtually invisible to prey while storing bait and using the bait as a lure

e. allow bait to appear and smell as it does naturally in the water

f. prevent the bait from actually being consumed by the target fish

g. attract target fish to local area to be caught by other means

All of this occurs without the user ever having to remove the bait from the apparatus once the bait has been placed into the apparatus at a bait shop or other bait source.

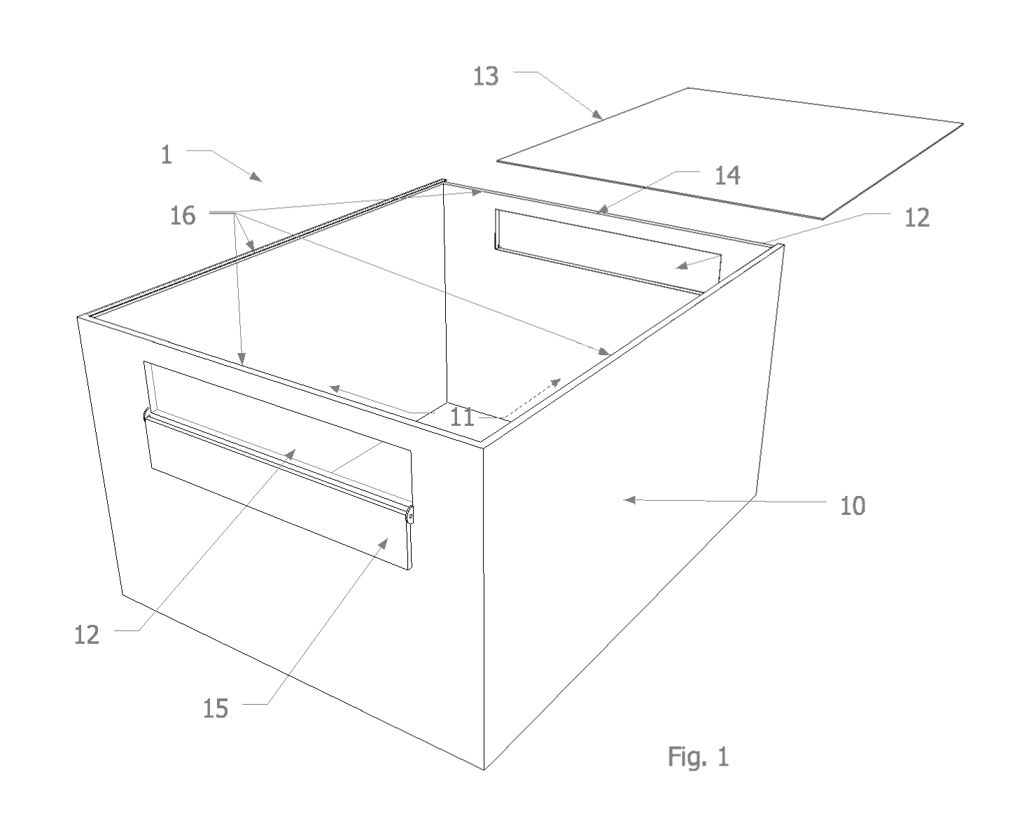

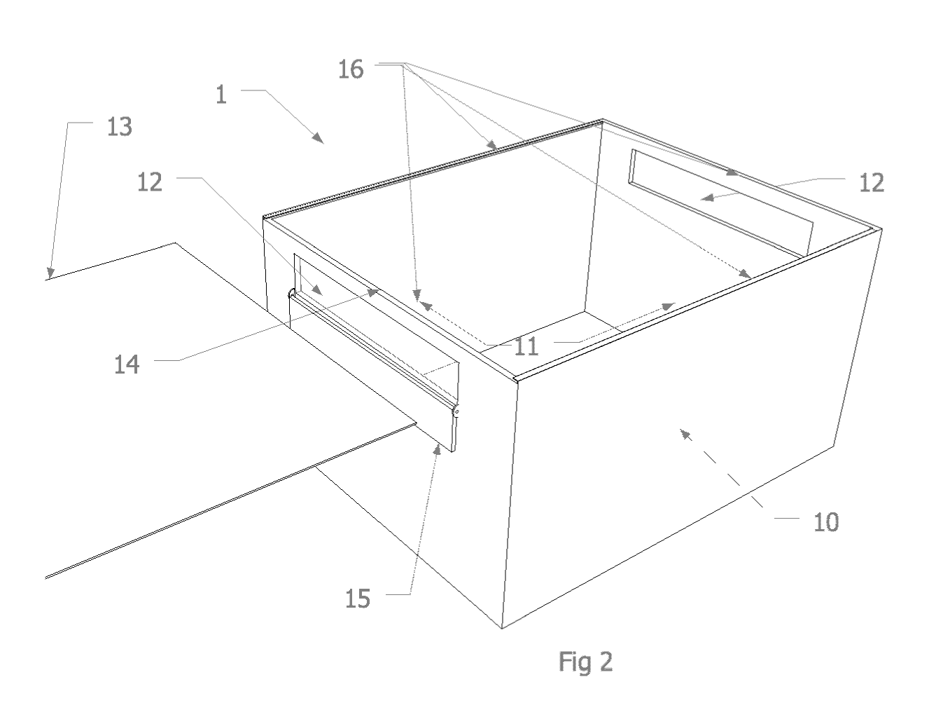

FIG. 1 is a front perspective view of the combination bait holder and fish lure apparatus 1 in a first preferred embodiment of the invention. In this illustration we see a substantially transparent container 10 comprising: a container opening 11 through which fishing bait and water can be introduced into and removed from the interior of container 10; and (in this non-limiting illustration, two) fluid passage openings 12 through which water can pass but the bait cannot pass. As stated earlier, fluid passage openings 12 may be implemented using holes and/or a semipermeable membrane and/or a screen mesh or equivalent. Also illustrated is a container opening closure 13 mating with container opening 11 for sealably closing container opening 11 such that the bait and water cannot pass therethrough. In this illustration, this mating occurs by sliding container opening closure 13 so as to close along the directional arrow 14, and the seal is provided around the upper circumference 16 of container 10 using sealing methods, devices and materials well known to those of ordinary skill in the art, such as, but not limited to, rubber, silicone, cork, plastic gaskets and equivalent materials. There are also (in this non-limiting illustration) two fluid passage closures 15 mating correspondingly with each of the passage openings 12 for sealably closing the fluid passage opening 12 such that the bait and water cannot pass therethrough. One of these fluid passage closures 15 is shown; the other hidden from the view of FIG. 1 but is illustrated in the opposite view of FIG. 2.

The method of using this combination bait holder and fish lure apparatus 1 is as follows: When a user of this apparatus 1 is obtaining bait at a location remote from a fishing location, such as but not limited to a bait shop, the user opens container opening 11 and closes all of fluid passage openings 12 using fluid passage closures 15, introduces the bait and water into container 10 through container opening 11, and then closes the container opening 11 using container opening closure 13, such that the bait and water are sealably contained within container 10.

Next, when the bait and water are contained within container 10, and container opening 11 and fluid passage openings 12 are sealably closed (using container opening closure 13 and fluid passage closures 15, respectively), the container 10 maybe transported from the remote location to the fishing location substantially without leakage, while storing and preserving the bait in a live condition;

Finally, when the user wishes to use the bait as a lure at the fishing location, the user opens at least one of the fluid passage openings 12 and completely submerges the combination bait holder and fish lure 1 into the water at the fishing location, and by virtue of the transparency of container 10, makes the bait visible to target fish, and by virtue of the at least one opened fluid passage opening 12, enables the target fish to also detect a scent of the bait, all without removing the bait from the combination bait holder and fish lure 1. As a consequence, the target fish may be lured toward combination bait holder and fish lure 1 to then be caught by other means (such as but not limited to a nearby fish hook with perhaps additional bait lure that can be consumed by the target fish, all not shown) proximate to this apparatus.

FIG. 2 is a rear perspective view of a preferred embodiment of the invention, taken in substantially the opposite direction from the view of FIG. 1.

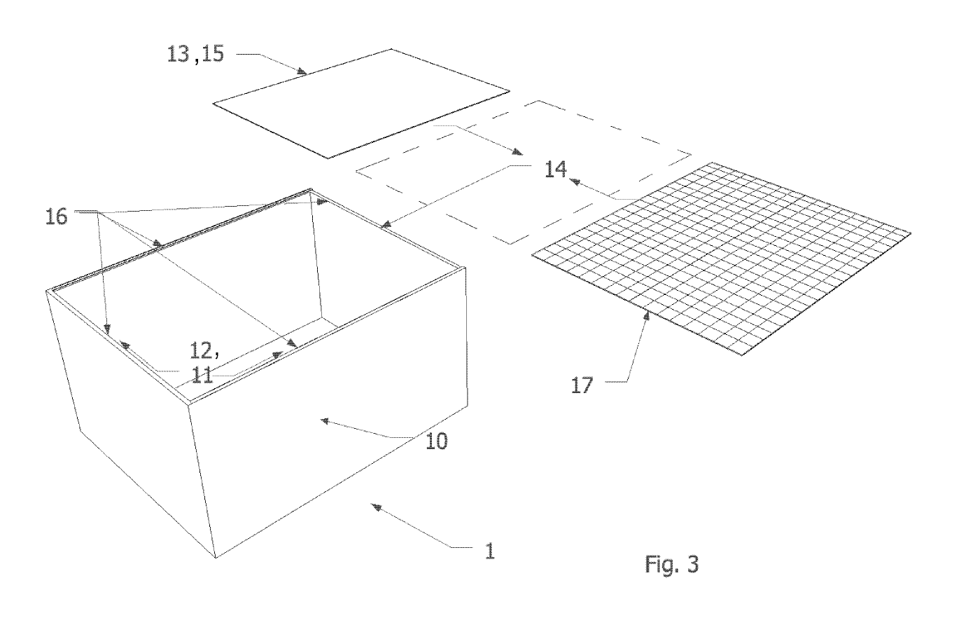

FIG. 3 is a perspective view of a second preferred embodiment in which the fluid passage opening 12 is convertible into the container opening 11. In this illustration, container opening 11 is one and the same as fluid passage opening 12, which in this embodiment, shall be referred to as a dual-purpose opening 11, 12. However, whereas in FIGS. 1 and 2 fluid passage openings 12 are inherently configured such that water can pass through but the bait cannot, dual-purpose opening 11, 12 is fully open to the passage of both fishing bait and water, in the manner of the container opening 11 of FIGS. 1 and 2. The requisite at least one fluid passage opening 12 through which water can pass but the bait cannot pass is implemented in this embodiment by way of a separate semipermeable barrier 17 through which water can pass but the bait cannot pass, attachable to and removable from container opening 11. As in the previous discussion, holes and/or a semipermeable membrane and/or a screen mesh or equivalent are all suitable implementations for semipermeable barrier 17.

When the user wishes to transport water and bait without leaking or spilling, the user closes container opening 11 using container opening closure 13, such that the bait and water are sealably 16 contained within container 10, just as in FIGS. 1 and 2. But when the user wishes to utilize combination bait holder and fish lure apparatus 1 as a lure, the container opening closure 13 is removed, and it is replaced by semipermeable barrier 17 through which water can pass but the bait cannot pass, attachable to and removable from said container opening along the directional arrow 14, in the same manner as container opening closure 13.

In this convertible embodiment, combination bait holder and fish lure apparatus 1 further comprises semipermeable 17 barrier through which water can pass but the bait cannot pass, attachable to and removable from 14 container opening 11; wherein: container opening 11 is convertible into one of the fluid passage openings 12 by attachment of semipermeable barrier 17 over container opening 11; and said one of the fluid passage openings 12 is convertible into container opening 11 by removal of semipermeable barrier 17 from over container opening 11. This convertibility thereby provides a dual-purpose opening 11, 12. Note that in this embodiment, the fluid passage closure 15 for the convertible fluid passage opening 11 is identical with the container opening closure 13 of FIG. 1, thereby providing a dual-purpose closure 13, 15.

It is preferred, though not required, to configure combination bait holder and fish lure apparatus 1 such that semipermeable barrier 17 can remain in place over container opening 11 while dual-purpose closure 13, 15 is also in place. That is, it is preferred, though not required, to have dual-purpose closure 13, 15 mating with dual-purpose opening 11, 12 for sealably 16 closing dual-purpose opening 11, 12 whether semipermeable barrier 17 is attached or not attached to dual-purpose opening 11, 12. This configuration is especially helpful for keeping all components of combination bait holder and fish lure apparatus 1 together, so they do not become separated and possibly lost.

Thus, for example, while the user is transporting combination bait holder and fish lure apparatus 1 with dual-purpose closure 13, 15 seated in place, semipermeable barrier 17 would also be seated, above or beneath dual-purpose closure 13, 15, simply for transport and storage.

When the user wishes to utilize combination bait holder and fish lure apparatus 1 as a lure, the user simply removes dual-purpose closure 13, 15 and the device is ready for luring, because semipermeable barrier 17 is already in place above or below dual-purpose closure 13, 15. In other words, the apparatus 1 is configured such that: when the bait and water are contained within container 10 and the dual-purpose opening 11, 12 is sealably closed, semipermeable barrier 17 remains attached to the dual-purpose opening 11, 12; and when the user wishes to use the bait as a lure at the fishing location, the user can remove the dual-purpose closure 13, 15 while leaving the semipermeable barrier 17 attached to dual-purpose opening 11, 12 and completely submerge the apparatus 1 into the water at the fishing location, thereby enabling the target fish to detect the scent of the bait via semipermeable barrier 17.

The foregoing drawings illustrate a combination bait holder and fish lure apparatus 1 which is preferably shaped as a rectangular parallelepiped, however, this is for illustration and not to be interpreted as limiting. Other variations to implement an apparatus such as is disclosed here, that provides dual convertible use as both a bait holder and a fish lure, will become apparent to those of ordinary skill based on a review of this disclosure, and are regarded as being within the scope of this disclosure and its associated claims.

It is understood that certain other elements, not shown here, may also be employed to add to the utility of combination bait holder and fish lure apparatus 1. For example, it may be desired to provide a carriage handle, for example, atop container opening closure 13, so that combination bait holder and fish lure apparatus 1 can easily be carried using that handle. It is also desirable to provide a connection that can attach combination bait holder and fish lure apparatus 1 to a rope line or similar device, see for example cord 140 in FIG. 9 of U.S. Pat. No. 4,841,664, so that the apparatus can readily be submerged and also retrieved after submersion. These particular elements, while understood to be desirable, are not illustrated in the drawings, because they are standard functional elements that are widely known, and are independent of the novelty and inventiveness of the combination bait holder and fish lure apparatus 1 disclosed in the foregoing.

While reference has been made throughout this disclosure to live bait, it is to be understood that any type of bait, not just fish bait and not just live bait, can be used in accordance with this invention within the scope of the associated claims. This may include for example, not limitation, crayfish, clams, insects, etc., and any other bait which a fisherman believes is effective for attracting the target fish to be caught.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A combination bait holder and fish lure apparatus, comprising:
a substantially transparent container comprising: a container opening through which fishing bait and water can be introduced into and removed from an interior of said container; and at least one fluid passage opening through which water can pass but the bait cannot pass;
a container opening closure mating with said container opening for sealably closing said container opening such that the bait and water cannot pass therethrough; and
at least one fluid passage closure mating correspondingly with said at least one fluid passage opening for sealably closing said at least one fluid passage opening such that the bait and water cannot pass therethrough; wherein said apparatus is configured such that:
when a user of said apparatus is obtaining said bait at a location remote from a fishing location, the user can open said container opening, and close all of said fluid passage openings using the fluid passage closures, introduce the bait and water into said container through said container opening, and then close said container opening using said container opening closure, such that the bait and water are sealably contained within said container;
when the bait and water are contained within said container and said container opening and said fluid passage openings are sealably closed, said container is capable of being transported from the remote location to the fishing location substantially without leakage, while storing and preserving the bait in a live condition;
when the user wishes to use the bait as a lure at the fishing location, the user can open at least one of said fluid passage openings and completely submerge said apparatus into the water at the fishing location, and by virtue of said container's transparency, make the bait visible to target fish, and by virtue of said at least one opened fluid passage opening, enable the target fish to also detect a scent of the bait, all without removing the bait from said apparatus; whereby:
said target fish may be lured toward said apparatus to then be caught by other means proximate to said apparatus.

2. The apparatus of claim 1, further comprising:
a semipermeable barrier through which water can pass but the bait cannot pass, attachable to and removable from said container opening; wherein:
said container opening is convertible into one of said fluid passage openings by attachment of said semipermeable barrier over said container opening; and
said one of said fluid passage openings is convertible into said container opening by removal of said semipermeable barrier from over said container opening;
this convertibility thereby provides a dual-purpose opening.

3. The apparatus of claim 2, wherein the fluid passage closure for the convertible fluid passage opening is identical with the container opening closure, thereby providing a dual-purpose closure.

4. The apparatus of claim 3, said dual-purpose closure mating with said dual-purpose opening for sealably closing said dual-purpose opening whether said semipermeable barrier is attached or not attached to said dual-purpose opening.

5. The apparatus of claim 4, wherein said apparatus is configured such that:
when the bait and water are contained within said container and said dual-purpose opening is sealably closed, said semipermeable barrier remains attached to said dual-purpose opening; and
when the user wishes to use the bait as a lure at the fishing location, the user can remove said dual-purpose closure while leaving said semipermeable barrier attached to said dual-purpose opening and completely submerge said apparatus into the water at the fishing location, thereby enabling the target fish to detect the scent of the bait via said semipermeable barrier.

6. The apparatus of claim 2, wherein a top of said container comprises said dual-purpose opening situated therein.

7. The apparatus of claim 2, wherein said apparatus is further configured such that bait food can pass through said dual-purpose opening.

8. The apparatus of claim 1, wherein said container opening is separate and distinct from any of said fluid passage openings.

9. The apparatus of claim 1, said container further comprising a substantially flat bottom for providing stability while said bait is being transported.

10. The apparatus of claim 1, wherein a top of said container comprises said container opening situated therein.

11. The apparatus of claim 1, wherein said apparatus is further configured such that bait food can pass through said container opening.

12. The apparatus of claim 1, wherein said container is substantially rectangular parallelepiped.

13. A method for storing and transporting fishing bait, and using the bait as a fish lure, using a single apparatus therefor, comprising:
providing a substantially transparent container comprising: a container opening through which bait and water can be introduced into and removed from an interior of said container; and at least one fluid passage opening through which water can pass but the bait cannot pass;
further providing a container opening closure mating with said container opening for sealably closing said container opening such that the bait and water cannot pass therethrough;
further providing at least one fluid passage closure mating correspondingly with said at least one fluid passage opening for sealably closing said at least one fluid passage opening such that the bait and water cannot pass therethrough;
at a location remote from a fishing location, opening said container opening, and closing all of said fluid passage openings using the fluid passage closures, introducing the bait and water into said container through said container opening, and then closing said container opening using said container opening closure, such that the bait and water are sealably contained within said container;
transporting said container and the bait and water contained therein to the fishing location substantially without leakage, while storing and preserving the bait in a live condition;
at the fishing location, opening at least one of said fluid passage openings and completely submerging said apparatus into the water at the fishing location;
using the bait as a lure, by making the bait visible to target fish by virtue of said container's transparency, and by enabling the target fish to also detect a scent of the bait by virtue of said at least one opened fluid passage opening; and
not removing the bait from said apparatus between said introducing and said submerging.

14. The method of claim 13, further comprising catching the target fish by other means proximate to said apparatus.

15. The method of claim 13, further comprising:
a semipermeable barrier through which water can pass but the bait cannot pass, attachable to and removable from said container opening; wherein:
said container opening is convertible into one of said fluid passage openings by attachment of said semipermeable barrier over said container opening; and
said one of said fluid passage openings is convertible into said container opening by removal of said semipermeable barrier from over said container opening;
this convertibility thereby provides a dual-purpose opening.

16. The method of claim 15, wherein the fluid passage closure for the convertible fluid passage opening is identical with the container opening closure, thereby providing a dual-purpose closure.

17. The method of claim 16, said dual-purpose closure mating with said dual-purpose opening for sealably closing said dual-purpose opening whether said semipermeable barrier is attached or not attached to said dual-purpose opening.

18. The method of claim 17, further comprising:
keeping said semipermeable barrier attached to said dual-purpose opening when the bait and water are contained within said container and said dual-purpose opening is sealably closed; and
using the bait as a lure by removing said dual-purpose closure while leaving said semipermeable barrier attached to said dual-purpose opening and completely submerging said apparatus into the water at the fishing location, thereby enabling the target fish to detect the scent of the bait via said semipermeable barrier.

19. The method of claim 15, wherein a top of said container comprises said dual-purpose opening situated therein.

20. The method of claim 15, further comprising feeding said bait through said dual-purpose opening.

21. The method of claim 13, wherein said container opening is separate and distinct from any of said fluid passage openings.

22. The method of claim 13, said container further comprising a substantially flat bottom for providing stability while said bait is being transported.

23. The method of claim 13, wherein a top of said container comprises said container opening situated therein.

24. The method of claim 13, further comprising feeding said bait through said container opening.

25. The method of claim 13, wherein said container is substantially rectangular parallelepiped.
